(19) United States
(12) Patent Application Publication
(10) Pub. No.: US 2026/0138851 A1
(43) Pub. Date: May 21, 2026

(54) LOST MOTION SLIDER FOR OPERATING AN ELEVATOR CAR DOOR INTERLOCK

(71) Applicant: OTIS ELEVATOR COMPANY, Farmington, CT (US)

(72) Inventors: James Chmiel, Suffield, CT (US); Michael J. Tracey, Cromwell, CT (US)

(21) Appl. No.: 18/952,171

(22) Filed: Nov. 19, 2024

(51) Int. Cl. B66B 13/16; B66B 13/08

(52) U.S. Cl. CPC B66B 13/16; B66B 13/08

(57) ABSTRACT

An assembly and method includes mounting at least one slider for linear movement with a belt that moves at least one elevator door between an open position and a closed position, and positioning a locking linkage to interact with the slider. The locking linkage and the slider contact each other to move the belt and unlock at least one car door connecting member prior to moving the elevator door to the open position.

### BACKGROUND

Elevators may be configured with center opening door panels that are belt driven. Elevator car door systems may be equipped with mechanical car door interlocks that require lost motion, or movement from a door operator to unlock before the door panels can move. A rotational linkage may be used to actuate car door interlocks; however, this type of linkage may be challenging to incorporate into existing door systems for lost motion purposes.

### SUMMARY

An illustrative example assembly includes: at least one elevator door movable between an open position and a closed position via a belt; at least one car door connecting member movable between a door lock position and a door unlock position; at least one slider mounted for linear movement with the belt, wherein the at least one slider includes one or more guide paths; a base bracket, wherein the at least one slider is moveable relative to the base bracket, and wherein the base bracket supports one or more guide members that are receivable within the one or more guide paths; and a locking linkage positioned to interact with the at least one slider, wherein the locking linkage is guided by a guide bracket held fixed relative to the at least one slider, and wherein the locking linkage and the at least one slider cooperate with each other to move the belt and unlock the at least one car door connecting member prior to moving the at least one elevator door to the open position.

In addition to one or more of the features described herein, or as an alternative, the one or more guide paths comprise at least a first guide path and a second guide path, and wherein the one or more guide members comprise at least a first guide member received within the first guide path and a second guide member received within the second guide path.

In addition to one or more of the features described herein, or as an alternative, the at least one slider comprises a slider block, and wherein the first guide path comprises a first slot that is open to one edge of the slider block and the second guide path comprises a second slot that is open to an opposite edge of the slider block.

In addition to one or more of the features described herein, or as an alternative, the slider block includes a first guide surface on an outer periphery of the slider block that is engageable by a first link of the locking linkage.

In addition to one or more of the features described herein, or as an alternative, the locking linkage includes a second link that is coupled to the first link at a pivot attachment, and wherein the guide bracket includes a second guide surface that is engageable by the second link.

In addition to one or more of the features described herein, or as an alternative, the pivot attachment is in a fixed position such that the first link and the second link pivot together about the pivot attachment in response to respective contact by the first guide surface and the second guide surface.

In addition to one or more of the features described herein, or as an alternative, the second guide surface comprises an arcuate surface that is engageable with a distal end of the second link.

In addition to one or more of the features described herein, or as an alternative, the at least one car door connecting member comprises at least one car door interlock, and wherein the slider block is moveable toward a door opening position and a door closing position, and including a resilient member coupled to the slider block, wherein the resilient member biases the slider block toward the door opening position.

In addition to one or more of the features described herein, or as an alternative, the one or more guide members comprise at least a first guide pin received within the first guide path and a second guide pin received within the second guide path, and wherein when the first guide pin hits a stop surface of the first slot during movement toward the door closing position, the slider block is further driven to compress the resilient member until the locking linkage reaches a stop position defined by the guide bracket.

In addition to one or more of the features described herein, or as an alternative, the at least one slider is only allowed to move in one linear direction which is defined as being in a same direction as belt movement.

An illustrative example assembly includes: mounting at least one slider for linear movement with a belt that moves at least one elevator door between an open position and a closed position; positioning a locking linkage to interact with the at least one slider; and the locking linkage and the at least one slider contacting each other to move the belt and unlock at least one car door connecting member prior to moving the at least one elevator door to the open position.

In addition to one or more of the features described herein, or as an alternative, the method may include only allowing the at least one slider to move in one linear direction which is defined as being in a same direction as belt movement.

In addition to one or more of the features described herein, or as an alternative, the method may include forming the at least one slider to include one or more guide paths, supporting one or more guide members on a base bracket that are receivable within the one or more guide paths, and wherein the at least one slider is moveable relative to the base bracket.

In addition to one or more of the features described herein, or as an alternative, the method may include guiding the locking linkage via a guide bracket held fixed relative to the at least one slider.

In addition to one or more of the features described herein, or as an alternative: the at least one slider comprises a slider block; the one or more guide paths comprise at least a first guide slot and a second guide slot that are formed within the slider block; the one or more guide members comprise at least a first guide pin received within the first guide slot and a second guide pin received within the second guide slot; and the locking linkage comprises at least a first link and a second link that are coupled together at a pivot attachment.

In addition to one or more of the features described herein, or as an alternative, the method may include: forming a first guide surface on an outer periphery of the slider block that is engageable by the first link; and forming a second guide surface on the guide bracket that is engageable by the second link.

In addition to one or more of the features described herein, or as an alternative, the method may include holding the pivot attachment in a fixed position such that the first link and the second link pivot together about the pivot attachment in response to respective contact by the first guide surface and the second guide surface.

In addition to one or more of the features described herein, or as an alternative, the second guide surface comprises an arcuate surface that is engageable with a distal end of the second link.

In addition to one or more of the features described herein, or as an alternative, the at least one car door connecting member comprises at least one car door interlock, and wherein the slider block is moveable toward a door opening position and a door closing position, and the method may include coupling a resilient member to the slider block and biasing the slider block toward the door opening position via the resilient member.

In addition to one or more of the features described herein, or as an alternative, when the first guide pin hits a stop surface of the first guide slot during movement toward the door closing position, the method may include continuing to drive the slider block to compress the resilient member until the locking linkage reaches a stop position defined by the guide bracket.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates a lost motion assembly in a door opening configuration.

FIG. 3 schematically illustrates a lost motion assembly in a door closing configuration.

FIG. 4 is an enlarged view of a portion of the lost motion assembly of FIG. 2.

FIG. 5 is an enlarged view of a portion of the lost motion assembly of FIG. 3.

FIG. 6 a flowchart diagram of an example method for using a locking linkage and a linearly moveable slider to move a belt and unlock a car door interlock prior to moving an elevator door to an open position.

### DETAILED DESCRIPTION

Embodiments of this disclosure provide an elevator door system with a lost motion assembly where a locking linkage and a linearly moveable slider cooperate with each other to move a belt and unlock a car door connecting member, such as a coupler or interlock, prior to moving an elevator door to an open position.

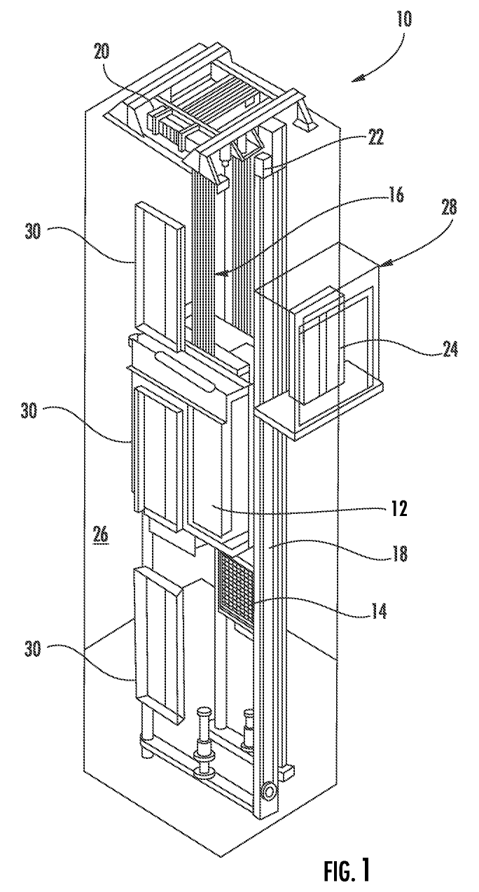

FIG. 1 is a perspective view of an elevator system 10 including an elevator car 12, a counterweight 14, a tension member 16, a guide rail 18, a machine 20, a position reference system 22, and a controller 24. The elevator car 12 and counterweight 14 are connected to each other by the tension member 16. The tension member 16 may include or be configured as, for example, ropes, steel cables, and/or coated-steel belts. The counterweight 14 is configured to balance a load of the elevator car 12 and is configured to facilitate movement of the elevator car 12 concurrently and in an opposite direction with respect to the counterweight 14 within an elevator shaft 26 and along the guide rail 18.

The tension member 16 engages the machine 20, which is part of an overhead structure of the elevator system 10. The machine 20 is configured to control movement between the elevator car 12 and the counterweight 14. The position reference system 22 may be mounted on a fixed part at the top of the elevator shaft 26, such as on a support or guide rail, and may be configured to provide position signals related to a position of the elevator car 12 within the elevator shaft 26. In other embodiments, the position reference system 22 may be directly mounted to a moving component of the machine 20, or may be located in other positions and/or configurations as known in the art. The position reference system 22 can be any device or mechanism for monitoring a position of an elevator car and/or counter weight, as known in the art. For example, without limitation, the position reference system 22 can be an encoder, sensor, or other system and can include velocity sensing, absolute position sensing and the like, as will be appreciated by those of skill in the art.

According to an aspect and as illustrated in FIG. 1, the controller 24 is located in a controller room 28 of the elevator shaft 26. The controller 24 may be configured to control the operation of the elevator system 10, and particularly the elevator car 12. For example, the controller 24 may provide drive signals to the machine 20 to control, for example, the acceleration, deceleration, leveling, stopping and the like, of the elevator car 12. The controller 24 may also be configured to receive position signals from the position reference system 22 or any other desired position reference device. When moving up or down within the elevator shaft 26 along guide rail 18, the elevator car 12 may stop at one or more landings 30 as controlled by the controller 24. Although shown in a controller room 28, those of skill in the art will appreciate that the controller 24 can be located and/or configured in other locations or positions within the elevator system 10. In one embodiment, the controller may be located remotely or in the cloud.

The machine 20 may include a motor or similar driving mechanism. In accordance with embodiments of the disclosure, the machine 20 is configured to include an electrically driven motor. The power supply for the motor may be any power source, including a power grid, which, in combination with other components, is supplied to the motor. The machine 20 may include a traction sheave that imparts force to tension member 16 to move the elevator car 12 within elevator shaft 26.

Although shown and described with a roping system including tension member 16, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

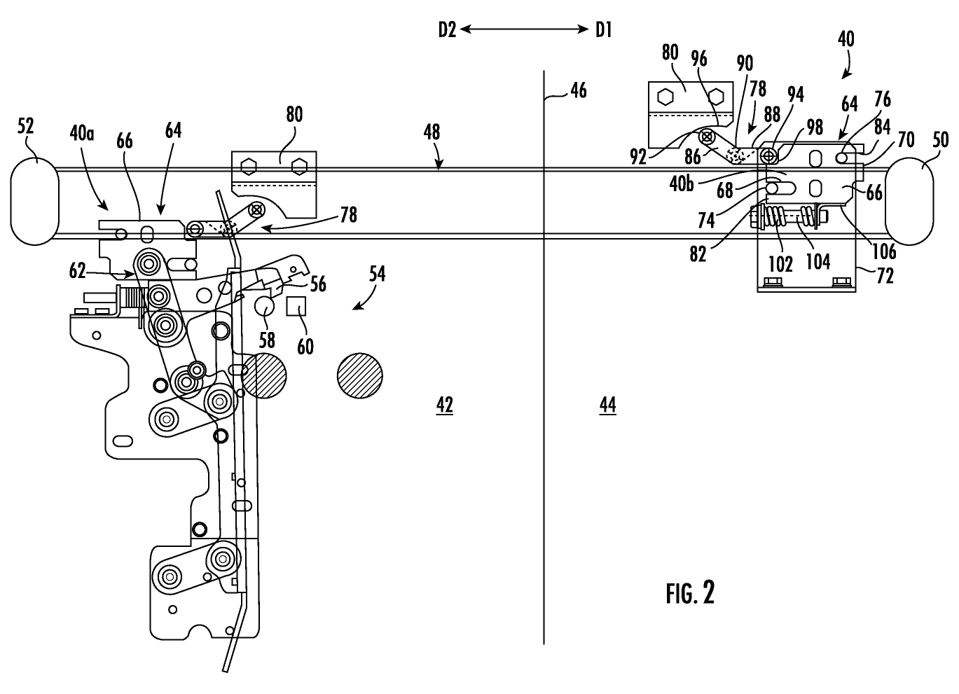

FIG. 2 shows a lost motion assembly 40 that is used to synchronize, in the elevator system 10, an opening and closing of one or more elevator doors. FIG. 2 shows an example of center opening doors that include a first door 42 and a second door 44 on opposing sides of a door center 46. In implementations, the lost motion assembly 40 includes a first lost motion device 40a associated with the first door 42 and a second lost motion device 40b associated with the second door 44. The doors 42, 44 may open responsive to a belt 48 moving in a first direction D1 and the doors 42, 44 may close responsive to the belt 48 moving in a second direction D2 that opposes the first direction D1. The belt 48 may be driven, for example, by a belt drive system that may include a motor 50 and pulley 52, which are illustrated schematically.

In some implementations, the lost motion assembly 40 may used to actuate door coupling or connecting mechanisms such as car door coupler or a car door, for example. One important aspect is that the lost motion assembly 40 does not need to be directly connected to such mechanisms. FIGS. 2-5 shown an example of an elevator door system with a car door interlock.

In some implementations, at least one car door interlock 54 is movable between a door lock position and a door unlock position. The car door interlock 54 may a combination of mechanical and/or electronic components that keep elevator doors closed until the elevator car has been properly aligned with regard to landing doors. When the elevator doors close, hooks or latches on the door engage with a locking mechanism. This interlock prevents the door from being opened while the elevator is in motion or between floors. In one example, an electromechanical lock may be used, which only allows the door to open when the elevator reaches the correct floor and stops completely. When the car reaches the floor, an electronic actuator, such as a solenoid for example, is energized, allowing a mechanical latch to disengage so the door can open.

Any type of car door interlock 54 can be utilized with the disclosed lost motion assembly 40. The car door interlock 54 shown in FIGS. 2-5 is just one example and it should be understood that other types of door interlocks could also be utilized.

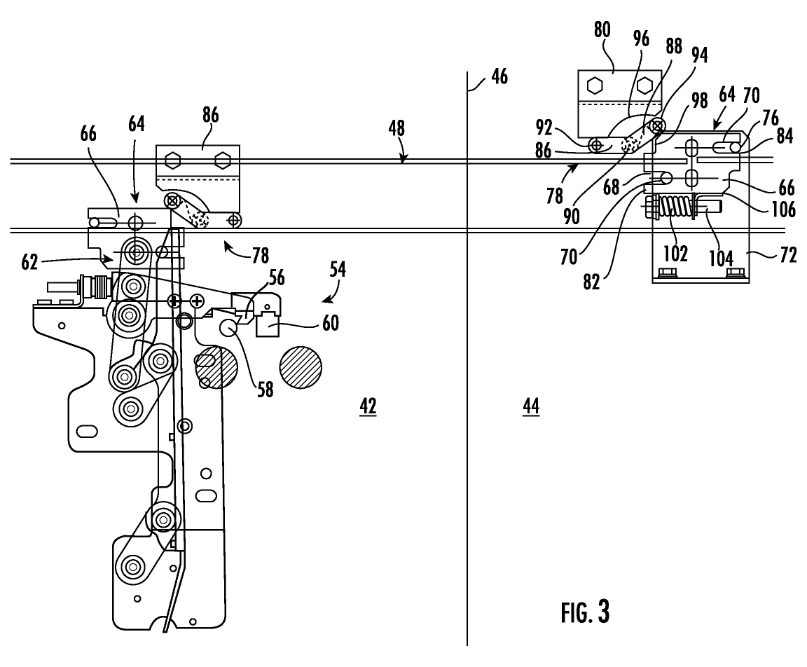

In the example of FIGS. 2-5, the car door interlock 54 has a hook 56 that cooperates with a locking element 58 and a sensing switch 60, which are shown schematically. In implementations, a vane system goes between two rollers on a landing door. The car door interlock 54 needs to sense the rollers to unlock. The lost motion assembly 40 is used to move the belt 48 prior to moving the doors 42, 44 so that the vane will drop down and sense the rollers. In one example, the lost motion device 40a associated with the first door 42 is coupled to the car door interlock 54 via a linkage assembly 62 that is associated with the hook 56. When the rollers are sensed, the linkage assembly 62 is toggled over to lift the hook 56 from the locked position (FIG. 3) and unlock the door (FIG. 2).

In some implementations, each lost motion device 40a, 40b includes one or more sliders 64 mounted for linear movement with the belt 48. In implementations, the sliders 64 do not rotate and are strictly fixed to move only along a linear path. In one example, the sliders 64 are only allowed to move in one linear direction which is defined as being in the same direction as belt movement.

In the example shown in FIGS. 2-5, each door 42, 44 includes a slider 64; however, the system could also be used for one door elevator configurations.

In an example, the slider 64 includes one or more guide paths. In the example shown in FIGS. 2-5, the slider 64 comprises a slider block 66 that includes at least a first guide path 68 and a second guide path 70.

In an example, the slider 64 is moveable relative to a base bracket 72 that supports one or more guide members, such as pins, arms, tabs and the like, which are receivable within the one or more guide paths. In one example, the base bracket 72 includes at least a first guide pin 74 that is receivable in the first guide path 68 and a second guide pin 76 that is receivable in the second guide path 70.

In some implementations, a locking linkage 78 is positioned to interact with the slider 64, wherein the locking linkage 78 is guided by a guide bracket 80 held fixed relative to the slider 64. The belt 48 cooperates with locking linkage 78 and slider 64 to unlock the car door interlock 54 prior to moving the elevator doors 42, 44 to the open position. In one example, locking linkage 78 locks slider 64 in place to restrict unintended motion between the belt 48 and the base bracket 72, such as the hanger drive plate for example.

In an example, the first guide path 68 comprises a first slot that is open to one edge 82 of the slider block 66 and the second guide path 70 comprises a second slot that is open to an opposite edge 84 of the slider block 66.

In some implementations, the locking linkage 78 comprises at least a first link 86 that is coupled to a second link 88 at a pivot attachment interface 90. The first link 86 extends from one end that is coupled to the second link 88, to a distal end 92 that interacts with the guide bracket 80. The second link 88 extends from one end that is coupled to the first link 86, to a distal end 94 that interacts with the slider block 66. In an example, the links 86, 88 are formed as one piece that pivots about interface 90. In another example, links 86, 88 are formed as separate pieces that are fixed together to pivot about interface 90.

In some implementations, the guide bracket 80 includes a first guide surface 96 that is engageable by the first link 86.

In some implementations, the slider block 66 includes a second guide surface 98, on an outer periphery of the slider block 66, which is engageable by the second link 88 of the locking linkage 78.

In some implementations, the pivot attachment interface 90 is in a fixed position such that the first link 86 and the second link 88 pivot together about the pivot attachment interface 90 in response to respective contact by the first guide surface 96 and the second guide surface 98.

In an example, the first guide surface 96 comprises an arcuate surface that is engageable with the distal end 92 of the first link 86.

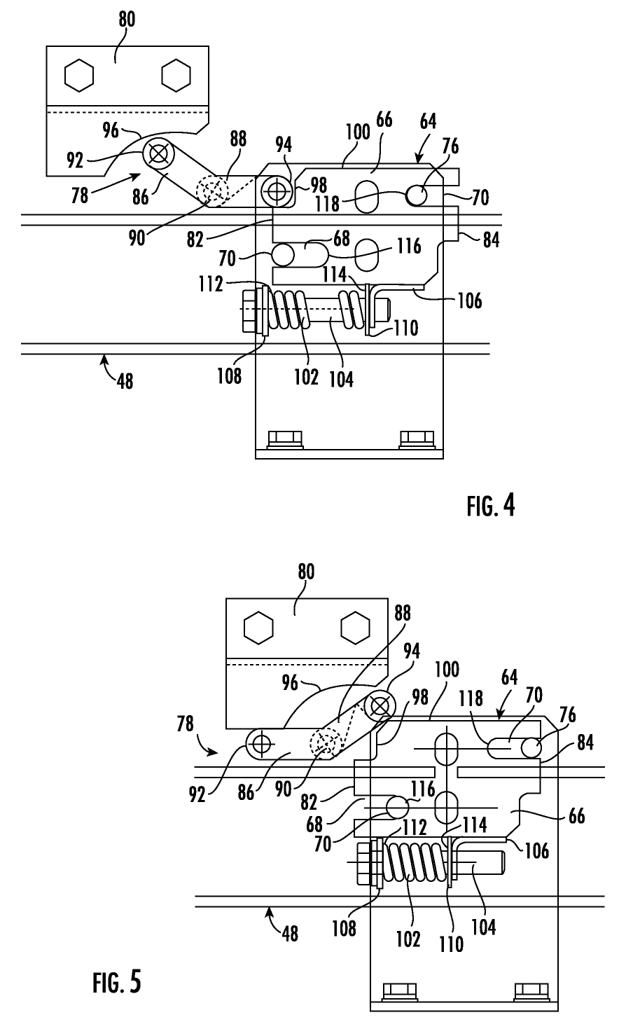

In an example, the second guide surface 98 comprises a recessed corner surface that guides the distal end 94 of the second link 88 up to a top edge 100 (FIGS. 4-5) of the slider block 66.

In some implementations, the slider block 66 is moveable toward a door opening position (FIGS. 2 and 4) and a door closing position (FIGS. 3 and 5). In one example, a resilient member 102 may be coupled to the slider block 66, wherein the resilient member 102 is configured to bias the slider block 66 toward the door opening position.

In an example, the resilient member 102 comprises a coil spring that surrounds a fastener body 104 that has one end fixed to the slider block 66 via a mounting bracket 106 An opposite end of the fastener body 104 comprises a head portion that seats a first washer 108, and a second washer 110 is seated against the mounting bracket 106. The coil spring has a first end 112 that reacts against the first washer 108 and a second end 114 that reacts against the second washer 110.

In some implementations, when the first guide pin 74 hits a stop/end surface 116 (FIG. 5) of the first slot 68 during movement toward the door closing position, the slider block 66 is further driven via the belt driven system to compress the resilient member 102 until the locking linkage 78 reaches a stop position defined by the guide bracket 80.

In some implementations, in the event of a loss of power, the biasing force of the compressed spring will allow the belt 48 to move and therefore will allow the lost motion slider block 66 to move thus actuating the car door interlock 54 and allowing the doors to open if properly aligned within a landing zone.

As shown in FIGS. 2 and 4, when in the door opening position, the slider block 66 has moved such that the stop/end surface 118 (FIG. 4) of the second slot 70 engages the second guide pin 76, and the first guide pin 74 has moved away from the end surface 116 (FIG. 4). The distal end 92 of the first link 86 has moved along the first guide surface 96 and extends at an oblique angle relative to the second link 88, which is orientated generally parallel to the direction of movement. The distal end 94 of the second link 88 is received within the corner recess area formed as part of the second guide surface 98 when in this position.

As shown in FIGS. 3 and 5, when in the door closing position, the slider block 66 has moved such that the second guide pin 76 has moved away from the stop/end surface 118 (FIG. 5) of the second slot 70, and the first guide pin 74 is in engagement with the end surface 116 (FIG. 5). The distal end 92 of the first link 86 has moved beyond the first guide surface 96 and extends generally parallel to the direction of movement. The second link 88 is at an oblique angle relative to the first link 86, and the distal end 94 of the second link 88 has moved beyond the corner recess area extends up to the top edge 100 of the slider block 66 when in this position.

The subject disclosure provides for a lost motion assembly with a slider mechanism that is attached to the belt and is only allowed to move in one linear direction, which is the same direction as belt movement. A base bracket with pin guides interacts with this slider mechanism and maintains linear movement along a belt axis. The slider mechanism has limiting travel to actuate the car door interlock and then transfers this movement into a car door hanger. This allows the slider mechanism to first move, actuating the car door interlock, and then transfers motion to the door panels. A locking linkage locks the slider mechanism during opening and closing phases of door operation. A resilient member is incorporated within the slider mechanism to provide actuation in the event of a power loss. In one example, unlocking is required in the event that power is lost within a door zone. As such, if power is lost, the biasing force of the compressed resilient member allows the slider mechanism to move toward the door opening position if the elevator is properly aligned with a landing.

The subject lost motion assembly also allows for the use of a modular car door interlock to be installed on an existing door operator with a variety of coupler variants. The slider mechanism keeps a belt hitch in line with the belt travel as the slider block moves, which is an advantage over rotating linkage connections used on other mechanical car door lock systems where the belt hitch must follow an arc. Additionally, the system is more flexible to varying track to belt heights, a dimension which can change depending on the door operator or opening type. This system can also be used with a configuration where a belt tensioner is mounted on the belt hitch, which was challenging for prior systems.

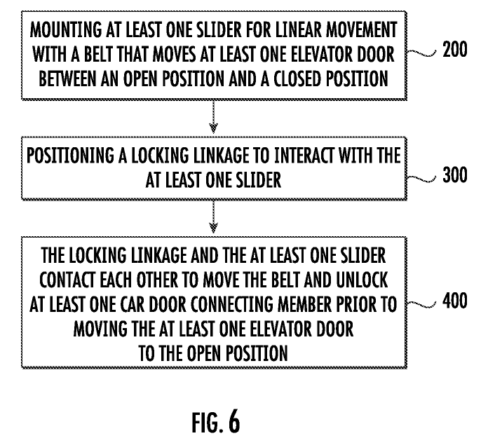

As shown in FIG. 6, the subject disclosure also provides for a method that includes: mounting at least one slider for linear movement with a belt that moves at least one elevator door between an open position and a closed position (see 200); positioning a locking linkage to interact with the at least one slider (see 300); and the locking linkage and the at least one slider contacting each other to move the belt and unlock at least one car door connecting member prior to moving the at least one elevator door to the open position (see 400).

The method can include any of the following features/steps either alone or in any combination thereof.

In an example, the method includes only allowing the at least one slider to move in one linear direction which is defined as being in a same direction as belt movement.

In an example, the method includes forming the at least one slider to include one or more guide paths, supporting one or more guide members on a base bracket that are receivable within the one or more guide paths, and wherein the at least one slider is moveable relative to the base bracket.

In an example, the method includes guiding the locking linkage via a guide bracket held fixed relative to the at least one slider.

In an example, the at least one slider comprises a slider block, the one or more guide paths comprise at least a first guide slot and a second guide slot that are formed within the slider block, the one or more guide members comprise at least a first guide pin received within the first guide slot and a second guide pin received within the second guide slot, and the locking linkage comprises at least a first link and a second link that are coupled together at a pivot attachment.

In an example, the method includes: forming a first guide surface on an outer periphery of the slider block that is engageable by the first link; and forming a second guide surface on the guide bracket that is engageable by the second link.

In an example, the method includes holding the pivot attachment in a fixed position such that the first link and the second link pivot together about the pivot attachment in response to respective contact by the first guide surface and the second guide surface.

In an example, the second guide surface comprises an arcuate surface that is engageable with a distal end of the second link.

In an example, the at least one car door connecting member comprises at least one car door interlock, and the slider block is moveable toward a door opening positing and a door closing position, and the method includes coupling a resilient member to the slider block and biasing the slider block toward the door opening position via the resilient member.

In an example, when the first guide pin hits a stop surface of the first guide slot during movement toward the door closing position, the method includes continuing to drive the slider block to compress the resilient member until the locking linkage reaches a stop position defined by the guide bracket.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An assembly comprising:
at least one elevator door movable between an open position and a closed position via a belt;
at least one car door connecting member movable between a door lock position and a door unlock position;
at least one slider mounted for linear movement with the belt, wherein the at least one slider includes one or more guide paths;
a base bracket, wherein the at least one slider is moveable relative to the base bracket, and wherein the base bracket supports one or more guide members that are receivable within the one or more guide paths; and
a locking linkage positioned to interact with the at least one slider, wherein the locking linkage is guided by a guide bracket held fixed relative to the at least one slider, and wherein the locking linkage and the at least one slider cooperate with each other to move the belt and unlock the at least one car door connecting member prior to moving the at least one elevator door to the open position.

2. The assembly of claim 1, wherein the one or more guide paths comprise at least a first guide path and a second guide path, and wherein the one or more guide members comprise at least a first guide member received within the first guide path and a second guide member received within the second guide path.

3. The assembly of claim 2, wherein the at least one slider comprises a slider block, and wherein the first guide path comprises a first slot that is open to one edge of the slider block and the second guide path comprises a second slot that is open to an opposite edge of the slider block.

4. The assembly of claim 3, wherein the slider block includes a first guide surface on an outer periphery of the slider block that is engageable by a first link of the locking linkage.

5. The assembly of claim 4, wherein the locking linkage includes a second link that is coupled to the first link at a pivot attachment, and wherein the guide bracket includes a second guide surface that is engageable by the second link.

6. The assembly of claim 5, wherein the pivot attachment is in a fixed position such that the first link and the second link pivot together about the pivot attachment in response to respective contact by the first guide surface and the second guide surface.

7. The assembly of claim 5, wherein the second guide surface comprises an arcuate surface that is engageable with a distal end of the second link.

8. The assembly of claim 3, wherein the at least one car door connecting member comprises at least one car door interlock, and wherein the slider block is moveable toward a door opening position and a door closing position, and including a resilient member coupled to the slider block, wherein the resilient member biases the slider block toward the door opening position.

9. The assembly of claim 8, wherein the one or more guide members comprise at least a first guide pin received within the first guide path and a second guide pin received within the second guide path, and wherein when the first guide pin hits a stop surface of the first slot during movement toward the door closing position, the slider block is further driven to compress the resilient member until the locking linkage reaches a stop position defined by the guide bracket.

10. The assembly of claim 1, wherein the at least one slider is only allowed to move in one linear direction which is defined as being in a same direction as belt movement.

11. A method comprising:
mounting at least one slider for linear movement with a belt that moves at least one elevator door between an open position and a closed position;
positioning a locking linkage to interact with the at least one slider; and
the locking linkage and the at least one slider contacting each other to move the belt and unlock at least one car door connecting member prior to moving the at least one elevator door to the open position.

12. The method of claim 11, including only allowing the at least one slider to move in one linear direction which is defined as being in a same direction as belt movement.

13. The method of claim 11, including forming the at least one slider to include one or more guide paths, supporting one or more guide members on a base bracket that are receivable within the one or more guide paths, and wherein the at least one slider is moveable relative to the base bracket.

14. The method of claim 13, including guiding the locking linkage via a guide bracket held fixed relative to the at least one slider.

15. The method of claim 14, wherein:
the at least one slider comprises a slider block;
the one or more guide paths comprise at least a first guide slot and a second guide slot that are formed within the slider block;
the one or more guide members comprise at least a first guide pin received within the first guide slot and a second guide pin received within the second guide slot; and
the locking linkage comprises at least a first link and a second link that are coupled together at a pivot attachment.

16. The method of claim 15, including:
forming a first guide surface on an outer periphery of the slider block that is engageable by the first link; and
forming a second guide surface on the guide bracket that is engageable by the second link.

17. The method of claim 16, including holding the pivot attachment in a fixed position such that the first link and the second link pivot together about the pivot attachment in response to respective contact by the first guide surface and the second guide surface.

18. The method of claim 17, wherein the second guide surface comprises an arcuate surface that is engageable with a distal end of the second link.

19. The method of claim 15, wherein the at least one car door connecting member comprises at least one car door interlock, and wherein the slider block is moveable toward a door opening position and a door closing position, and including coupling a resilient member to the slider block and biasing the slider block toward the door opening position via the resilient member.

20. The method of claim 19, wherein when the first guide pin hits a stop surface of the first guide slot during movement toward the door closing position, continuing to drive the slider block to compress the resilient member until the locking linkage reaches a stop position defined by the guide bracket.
